(19) United States
(12) Patent Application Publication
(10) Pub. No.: US 2005/0195282 A1
(43) Pub. Date: Sep. 8, 2005

(54) Auto-steering waterproof video camera monitor

(76) Inventor: David Wei, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 10/793,488

(22) Filed: Mar. 4, 2004

(51) Int. Cl. H04N 5/225

(52) U.S. Cl. 348/207.99

(57) ABSTRACT

An auto-steering waterproof video camera monitor is disclosed and claimed, which comprises a housing holding a lens assembly for optical input and for converting inputted light signal into electronic signal for transmission through a signal output at the rear side of the housing, a gasket ring sealing the housing against outside water, a rotary shaft extended out of the housing for mounting on an external support, and a micro switch-controlled motor coupled to the rotary shaft and adapted to turn the housing and the lens assembly about the rotary shaft within a predetermined range of angles.

### BACKGROUND OF THE INVENTION

1. Field of the Invention

The present invention relates generally to a video camera monitor and, more particularly, to an auto-steering waterproof video camera monitor.

2. Description of the Related Art

To constantly keep watch over a particular place, a video camera monitor may be used. By means of a video camera monitor, the user can keep watch over a particular space from a remote site. However, in order to move the video camera monitor alternatively back and forth within a predetermined range of angles, a special rotary rack may be used. A rotary rack for this purpose is expensive. Further, the installation of such a rotary rack at the job site can also be complicated.

### BRIEF SUMMARY OF THE INVENTION

The present invention has been accomplished under the circumstances in view. It is the main object of the present invention to provide a video camera monitor, which automatically reversibly turns back and forth within a range of angles to monitor the assigned place when installed. It is another object of the present invention to provide a video camera monitor which is waterproof.

To achieve these and other objects of the present invention, the video camera monitor comprises a housing, the housing comprising a top cover shell and a bottom cover shell and defining an enclosed receiving space between the top cover shell and the bottom cover shell; a lens assembly fastened to the housing, the lens assembly comprising a lens rotatable to adjust the focal length thereof for input of light, a photo sensor adapted to convert light signal into electronic signal, and a water gasket ring mounted in between the lens assembly and the housing to seal against outside water; a signal output provided at a rear side of the housing opposite to the lens assembly for transmitting the electronic signal from the photo sensor; and a transmission mechanism, the transmission mechanism comprising a rotary shaft rotatably mounted in the bottom cover shell of the housing and connectable to an external support, a reversible motor fixedly mounted inside the bottom cover shell and coupled to the rotary shaft and adapted to rotate the rotary shaft, a control circuit module mounted inside the bottom cover shell and adapted to control the operation of the reversible motor, a first micro switch and a second micro switch electrically connected to the control circuit module and disposed at two opposite sides relative to the rotary shaft and adapted to reverse the direction of rotation of the reversible motor when triggered, and a triggering rod fixedly fastened to the rotary shaft between the first micro switch and the second micro switch and adapted to trigger the first micro switch and the second micro switch alternatively during operation of the reversible motor.

### BRIEF DESCRIPTION OF THE DRAWINGS

FIG. 1 is an exploded view of an auto-steering waterproof video camera monitor according to the present invention.

FIG. 2 is an elevational assembly view of the auto-steering waterproof video camera monitor according to the present invention.

FIG. 3 is another elevational view of the auto-steering waterproof video camera monitor according to the present invention when viewed from another side.

FIG. 4 is an exploded view inside the housing of the video camera monitor of the present invention.

FIG. 5 is an assembly view of FIG. 4.

FIG. 6 is an elevational view of an alternate form of the auto-steering waterproof video camera monitor according to the present invention.

FIG. 7 is an elevational view of another alternate form of the auto-steering waterproof video camera monitor according to the present invention.

FIG. 8 is an elevational view of still another alternate form of the auto-steering waterproof video camera monitor according to the present invention.

### DETAILED DESCRIPTION OF THE PREFERRED EMBODIMENT

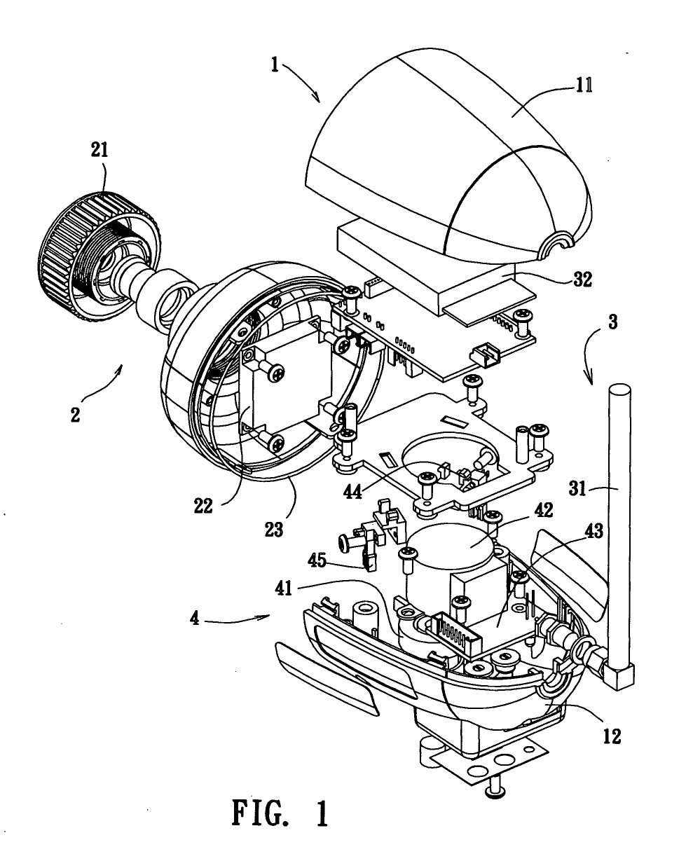

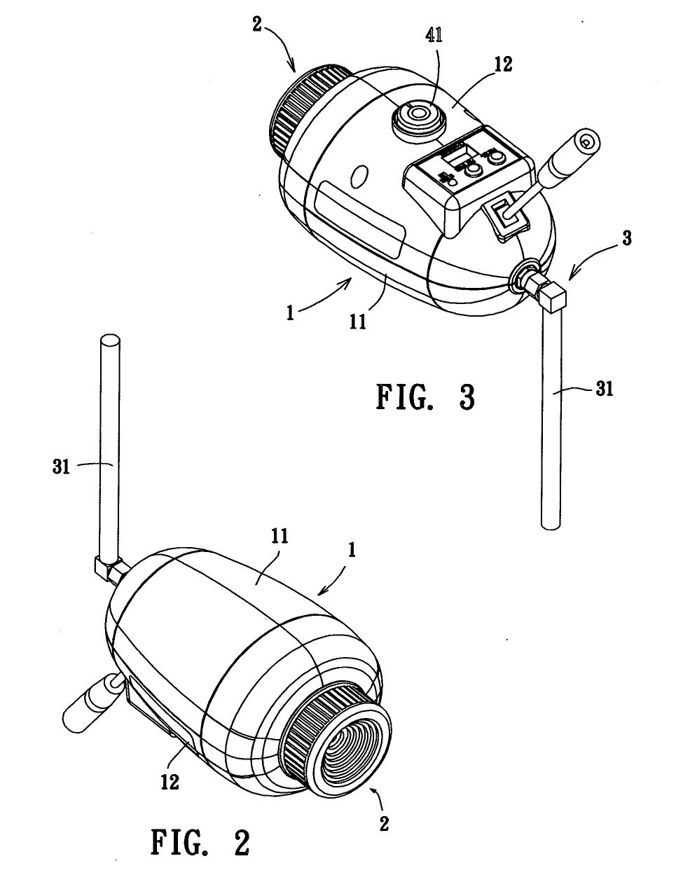

Referring to FIGS. 1˜5, an auto-steering waterproof video camera monitor in accordance with the present invention is mountable on any of a variety of supports, and adapted to pick up images of a particular place and to convert the images into electronic signal for transmission.

The video camera monitor comprises a housing 1, a lens assembly 2, a signal output 3, and a transmission mechanism 4.

The housing 1 is formed of a top cover shell 11 and a bottom cover shell 12, defining a receiving space between the top cover shell 11 and the bottom cover shell 12.

The lens assembly 2 is fastened to the housing 1, comprising a lens 21 that can be rotated to adjust the focal length for input of light, a photo sensor 22 adapted to convert light signal into an electronic signal, and a water gasket ring 23 mounted in between the lens assembly 2 and the housing 1 to seal the gap against water.

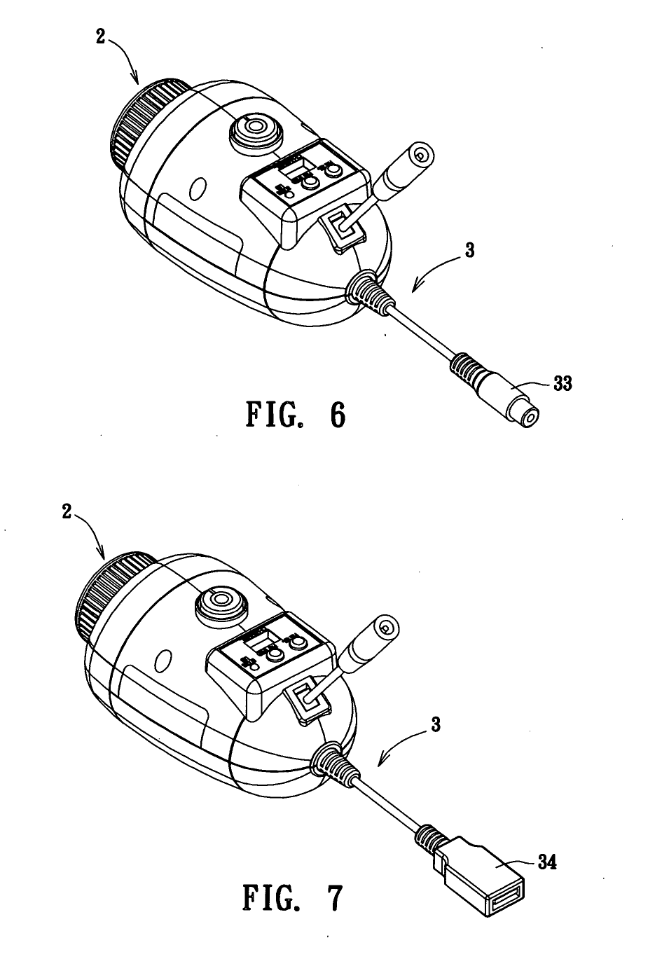

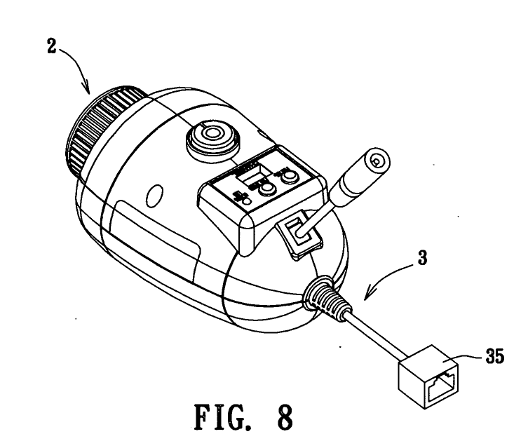

The signal output 3 is provided at the rear side of the housing 1 between the top cover shell 11 and the bottom cover shell 12 for transmitting the electronic signal from the photo sensor 22. According to the present preferred embodiment, the signal output 3 can be made to comprise a modulator module 32 mounted inside the housing 1 and electrically connected to the output end of the photo sensor 22 and adapted to modulate the electronic signal from the photo sensor 22 into a radio signal, and a radio signal transmitting antenna 31 adapted to send the radio signal from the modulator module 32 into the air by radio in order to be received by a remote radio receiver (not shown). Alternatively, the signal output 3 can be made to comprise an AV (audio/video) terminal 33 as shown in FIG. 6, a USB (universal serial bus) connector 34 as shown in FIG. 7 for connection to a computer, or a network connector 35 as shown in FIG. 8 for connection to the Internet or an intranet to allow the images taken by the video camera monitor to be monitored by a remote computer.

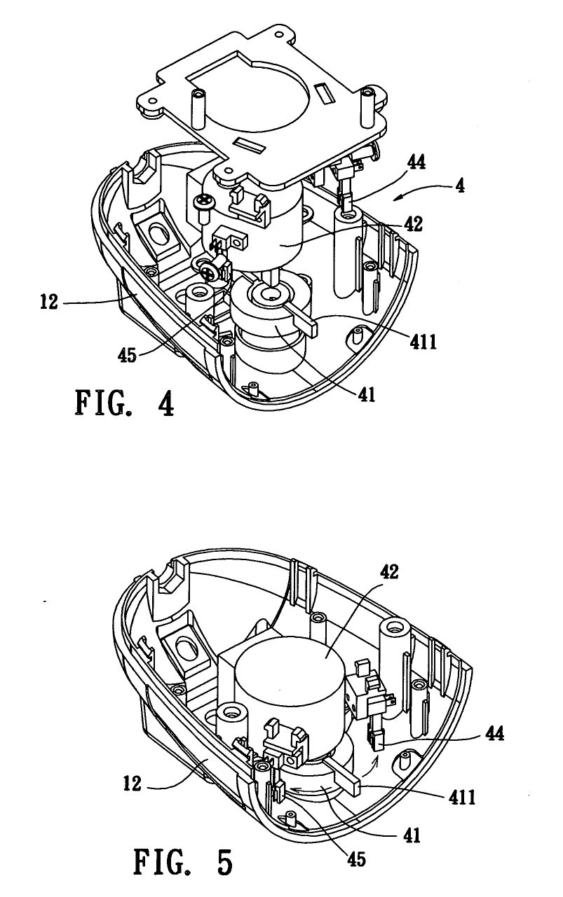

As shown in FIGS. 4 and 5, the transmission mechanism 4 comprises a rotary shaft 41 rotatably mounted inside the bottom cover shell 12 of the housing 1, a reversible motor 42 fixedly mounted inside the bottom cover shell 12 and coupled to the rotary shaft 41 and adapted to rotate the rotary shaft 41 clockwise and counter-clockwise, a control circuit module 43 mounted inside the bottom cover shell 12 and adapted to control the operation of the reversible motor 42, a first micro switch 44 and a second micro switch 45 electrically connected to the control circuit module 43 and disposed at two opposite sides relative to the rotary shaft 41, and a triggering rod 411 fixedly fastened to the periphery of the rotary shaft 41 between the first micro switch 44 and the second micro switch 45.

When in use, the rotary shaft 41 is affixed to the support (not shown) and kept immovable. When the reversible motor 42 is started, the whole assembly of the video camera monitor is forced to turn about the rotary shaft 41 alternatively forwards and backwards between the first micro switch 44 and the second micro switch 45, i.e., when one micro switch 44 or 45 touches the triggering rod 411, the reversible motor 42 is caused to reverse the direction of rotation. Therefore, the video camera monitor automatically continuously turns back and forth within a predetermined range of angles.

While only one embodiment of the invention has been described in detail for purposes of illustration, it is understood that various modifications and enhancements can be made without departing from the spirit and scope of the invention. Accordingly, the invention is not to be limited except as by the appended claims.

1. A video camera monitor comprising
a housing, said housing comprising a top cover shell and a bottom cover shell and defining an enclosed receiving space between said top cover shell and said bottom cover shell;
a lens assembly fastened to said housing, said lens assembly comprising a lens rotatable to adjust the focal length thereof for input of light, a photo sensor adapted to convert light signal into an electronic signal, and a water gasket ring mounted in between said lens assembly and said housing to seal against outside water;
a signal output provided at a rear side of said housing opposite to said lens assembly for transmitting the electronic signal from said photo sensor; and
a transmission mechanism, said transmission mechanism comprising a rotary shaft rotatably mounted in said bottom cover shell of said housing and connectable to an external support, a reversible motor fixedly mounted inside said bottom cover shell and coupled to said rotary shaft and adapted to rotate said rotary shaft, a control circuit module mounted inside said bottom cover shell and adapted to control the operation of said reversible motor, a first micro switch and a second micro switch electrically connected to said control circuit module and disposed at two opposite sides relative to said rotary shaft and adapted to reverse the direction of rotation of said reversible motor when triggered, and a triggering rod fixedly fastened to said rotary shaft between said first micro switch and said second micro switch and adapted to trigger said first micro switch and said second micro switch alternatively during operation of said reversible motor.

2. The video camera monitor as claimed in claim 1, wherein said signal output comprises an AV (audio/video) terminal.

3. The video camera monitor as claimed in claim 1, wherein said signal output comprises a modulator module and a radio transmitting antenna.

4. The video camera monitor as claimed in claim 1, wherein said signal output comprises a USB (universal serial bus) connector.

5. The video camera monitor as claimed in claim 1, wherein said signal output comprises a network connector.
